(19) United States
(12) Patent Application Publication
(10) Pub. No.: US 2014/0108034 A1
(43) Pub. Date: Apr. 17, 2014

(54) CONTINUOUS AUTOMATED HEALTHCARE ENTERPRISE RESOURCE ASSIGNMENT SYSTEM AND METHOD

(71) Applicants: Kunter Seref Akbay, Niskayuna, NY (US); Srinivas Bollapragada, Niskayuna, NY (US); Andrew Phelps Day, Newtown, PA (US); Ilkin Onur Dulgeroglu, Niskayuna, NY (US); David S. Toledano, Niskayuna, NY (US); Bex George Thomas, Niskayuna, NY (US); Marcia Peterson, Niskayuna, NY (US); Dan Yang, Niskayuna, NY (US)

(72) Inventors: Kunter Seref Akbay, Niskayuna, NY (US); Srinivas Bollapragada, Niskayuna, NY (US); Andrew Phelps Day, Newtown, PA (US); Ilkin Onur Dulgeroglu, Niskayuna, NY (US); David S. Toledano, Niskayuna, NY (US); Bex George Thomas, Niskayuna, NY (US); Marcia Peterson, Niskayuna, NY (US); Dan Yang, Niskayuna, NY (US)

(21) Appl. No.: 14/044,326

(22) Filed: Oct. 2, 2013

Related U.S. Application Data
(60) Provisional application No. 61/712,612, filed on Oct. 11, 2012.

(51) Int. Cl. G06Q 10/06; G06Q 50/22

(52) U.S. Cl. CPC G06Q 10/06315; G06Q 50/22
USPC 705/2

(57) ABSTRACT

Current resource data may be continuously and automatically received indicative of a current state of resources that are used to deliver healthcare to a plurality of patients associated with a healthcare enterprise. The current resource data may be automatically used to update a healthcare enterprise simulation model. The healthcare enterprise simulation model may be executed to automatically generate a predicted future state of the resources. A resource request may then be received, and a resource assignment engine may automatically assign a particular resource to the resource request based at least in part on the predicted future state of the resources.

### CROSS-REFERENCE TO RELATED APPLICATIONS

The present application claims the benefit of U.S. Provisional Patent Application Ser. No. 61/712,612 entitled “CONTINUOUS AUTOMATED RESOURCE ASSIGNMENT SYSTEM” and filed on Oct. 11, 2012. The entire content of that application is incorporated herein by reference.

### BACKGROUND

A healthcare enterprise, such as a hospital, may utilize resources to deliver healthcare to patients. For example, a hospital may have a limited number of hospital beds that can be assigned to patients. As a result, resource and patient flow management may be an important responsibility of a healthcare provider. In some cases, a balance between inpatient bed capacity/staffing levels and current/expected patient demand may need to be maintained across a period of time (e.g., through the next 24 hours). To help maintain such a balance, a healthcare provider may re-target patient placements and/or open or close healthcare units and beds based on existing and upcoming capacity and demand.

Failing to properly manage resource and patient flow may result in substantial admission waits (e.g., “boarding” patients in an emergency department) and reduce safety due to imbalances between nurse staffing and current inpatient census (often as a result of unforeseen variability in patient flow). Moreover, failing to manage patient bed occupancy may result in higher overall medical costs by increasing the average duration of inpatient stays, causing unnecessary ambulance diversions, etc.

Typically, a healthcare provider focuses on quantifying current conditions and deterministic future events. In many cases, however, a throughput crisis may not be fully appreciated until after the consequences have already affected the facility. At many facilities, operational success depends on a few select individuals who attempt to track patient flow through the entire organization and “bed huddle” meetings to assess daily capacity needs. For example, bed huddle meetings (usually held in the morning and in the late afternoon) may let managers with operational decisioning responsibilities in key departments/units meet in person and provide specific current census and anticipated patient admissions, discharges, and transfers. A net bed demand may be estimated based on the starting occupancy and anticipated inflows and outflows for each unit and then be further adjusted based on the staff availability. Such an approach, however, is manually intensive and depends on each person's judgment. Furthermore, it may be difficult to predict potential bottlenecks and there is little ability to assess outcomes that may result if certain actions were taken to avoid potential problems proactively.

It would therefore be desirable to provide systems and methods to facilitate accurate resource and patient flow management in an automated, efficient, and consistent manner.

### BRIEF DESCRIPTION OF THE DRAWINGS

FIG. 1 is block diagram of a system according to some embodiments of the present invention.

FIG. 2 illustrates a method that might be performed in accordance with some embodiments.

FIG. 3 illustrates a patient flow model at a “molecule” level according to some embodiments of the present invention.

FIG. 4 illustrates a hospital patient flow according to some embodiments of the present invention.

FIG. 5 illustrates a unit level forecast according to some embodiments of the present invention.

FIG. 6 illustrates a high level workflow according to some embodiments of the present invention.

FIG. 7 illustrates a resource request display according to some embodiments of the present invention.

FIG. 8 illustrates a resource assignment display according to some embodiments of the present invention.

FIG. 9 is block diagram of a tool or platform according to some embodiments of the present invention.

FIG. 10 is a tabular portion of a resource assignment database according to some embodiments.

FIG. 11 illustrates a configuration setup display in accordance with some embodiments.

FIG. 12 illustrates a bed assignment model that might be provided according to some embodiments.

FIG. 13 illustrates a reference architecture that might be provided according to some embodiments.

FIG. 14 illustrates a tier structure that might be provided in accordance with some embodiments.

FIG. 15 illustrates a method that might be performed in accordance with some embodiments.

FIG. 16 is an example of a cloud based bed management approach according to some embodiments.

FIG. 17 is a system diagram for a continuous automated bed-patient management system in accordance with some embodiments.

### DETAILED DESCRIPTION

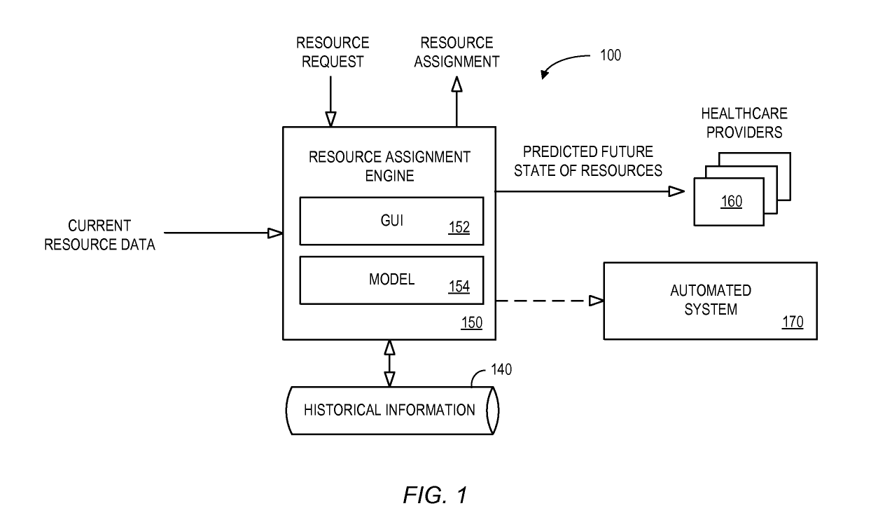

A healthcare enterprise, such as a hospital, may utilize “resources” to deliver healthcare to patients. Note that the term resources might refer to, by ways of examples, patient beds and/or rooms, healthcare providers and other staff of an enterprise, and/or medical equipment. For example, a hospital may have a limited number of hospital beds that can be assigned to patients. As a result, resource and patient flow management may be an important responsibility of a healthcare provider and it would therefore be desirable to provide systems and methods to facilitate accurate resource and patient flow management in an automated, efficient, and consistent manner. FIG. 1 is block diagram of a system 100 according to some embodiments of the present invention. In particular, the system 100 includes a resource assignment engine 150 that receives current resource data (e.g., from a real time location system). According to some embodiments, the resource assignment engine 150 may also receive information, such as electronic files, from other hospital information systems, such as Admission Discharge Transfer (“ADT”) data. The resource assignment engine 150 may also access a historical information database 140 (e.g., to predict how many patients will visit an emergency department on a Sunday afternoon). The resource assignment engine 150 might be, for example, associated with a Personal Computers (PC), laptop computer, an enterprise server, a server farm, and/or a database or similar storage devices. The resource assignment engine 150 may, according to some embodiments, be associated with a hospital.

Some embodiments described herein may facilitate the management of resources (e.g., beds, staff, and/or equipment) in hospital operations. Moreover, an optimization framework (e.g., with rules, objectives and constraints) may be provided along with, in some cases, a simulation model that can look ahead in time. A data framework may be associated with real time and/or snapshot data. According to some embodiments, some or all of a framework may be locally deployed on-premise and/or be deployed in a cloud environment. In addition, some embodiments may facilitate the management of resources via a continuous, automated process (either with or without human intervention). In addition, some embodiments described herein may incorporate online and/or offline learning to adjust and improve resource deployment rules.

According to some embodiments, an “automated” resource assignment engine 150 may facilitate resource and patient flow management using a Graphical User Interface (“GUI”) 152. As used herein, the term “automated” may refer to, for example, actions that can be performed with little or no human intervention. In some embodiments, a healthcare enterprise simulation model 154 may use the current resource data and generate a predicted future state of resources that can be provided to healthcare professionals 160, such as nurses or managers. Moreover, the resource assignment engine 150 may receive resource requests (e.g., a request for patient bed) and automatically transmit resource assignments in response to the requests. According to some embodiments, the resource assignment engine 150 might also transmit information to an external automated system 170, such as a report generator, workflow application, or email notification system.

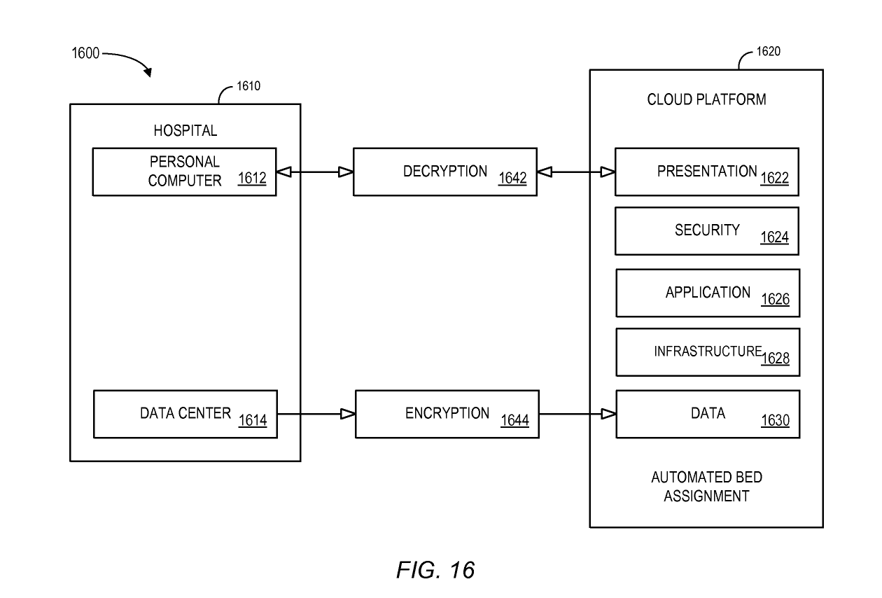

As used herein, devices, including those associated with the resource assignment engine 150 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks. Moreover, as described with respect to FIG. 16, some embodiments may be implemented in a “cloud” based environment such that at least some of the processing is performed by a remote system.

The resource assignment engine 150 may store information into and/or retrieve information from the historical information database 140. The historical information database 140 may be locally stored or reside remote from the resource assignment engine 150. Although a single resource assignment engine 150 is shown in FIG. 1, any number of such devices may be included. Moreover, various devices described herein might be combined according to embodiments of the present invention. For example, in some embodiments, the resource assignment engine 150 and historical information database 140 might be co-located and/or may comprise a single apparatus.

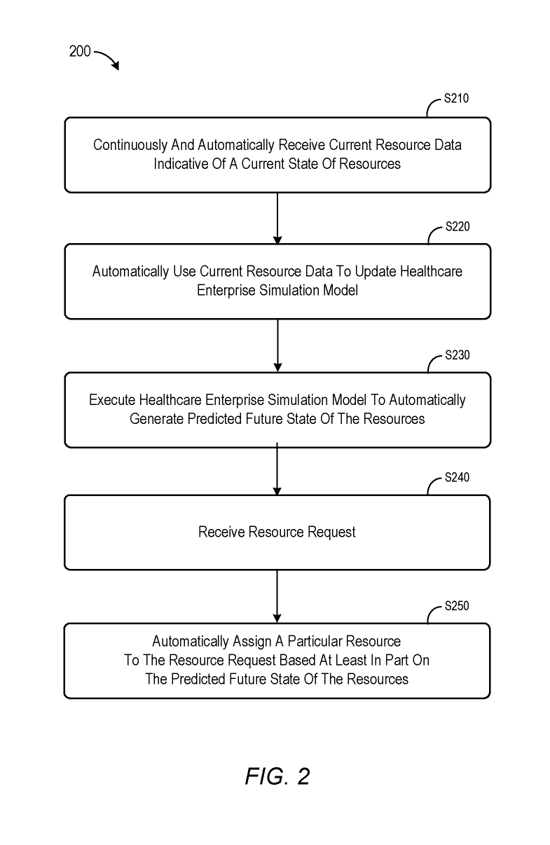

FIG. 2 illustrates a method that might be performed by some or all of the elements of the system 100 described with respect to FIG. 1. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, current resource data is received indicative of a current state of resources that deliver healthcare to a plurality of patients associated with a healthcare enterprise. According to some embodiments, the method 200 of FIG. 2 is periodically performed in substantially real time (e.g., every minute). Other embodiments may determine the current resource state on an as-needed basis (e.g., when a request for a resource is received). The resources may be associated with, for example, patient beds, staffing, and/or medical equipment and the current resource data may be received from, for example, a real time location system utilizing Radio Frequency Identifier (“RFID”) information.

At S220, the received current resource data is automatically used to update a healthcare enterprise simulation model. Note that the model may have been previously configured based on the structure of the healthcare enterprise. For example, the configuration might involve defining a plurality of treatment “units” of the healthcare enterprise simulation model and defining patient flow characteristics into, within, between, and out of the plurality of treatment units. As used herein, phrase “treatment unit” might refer to, for example, an emergency department, an outpatient unit, a holding room, an operating room, a recovery room, a cardiac treatment unit, a physical therapy unit, a laboratory, an X-ray and MRI unit, and/or an intensive care unit.

At S230, the healthcare enterprise simulation model is executed to generate a predicted future state of the resources. For example, the model might predict a number of available patient beds over the next 24 hours. According to some embodiments, the model generates a plurality of predicted future states of the resources, each associated with a different point in time. According to some embodiments, the model also receives scheduled future events and the predicted future state of the resources is further based on the scheduled future events (e.g., how many surgeries are scheduled for a particular day). Note that the predicted future state of the resources may also be based on predicted future events (e.g., based at least in part historical information of the healthcare enterprise).

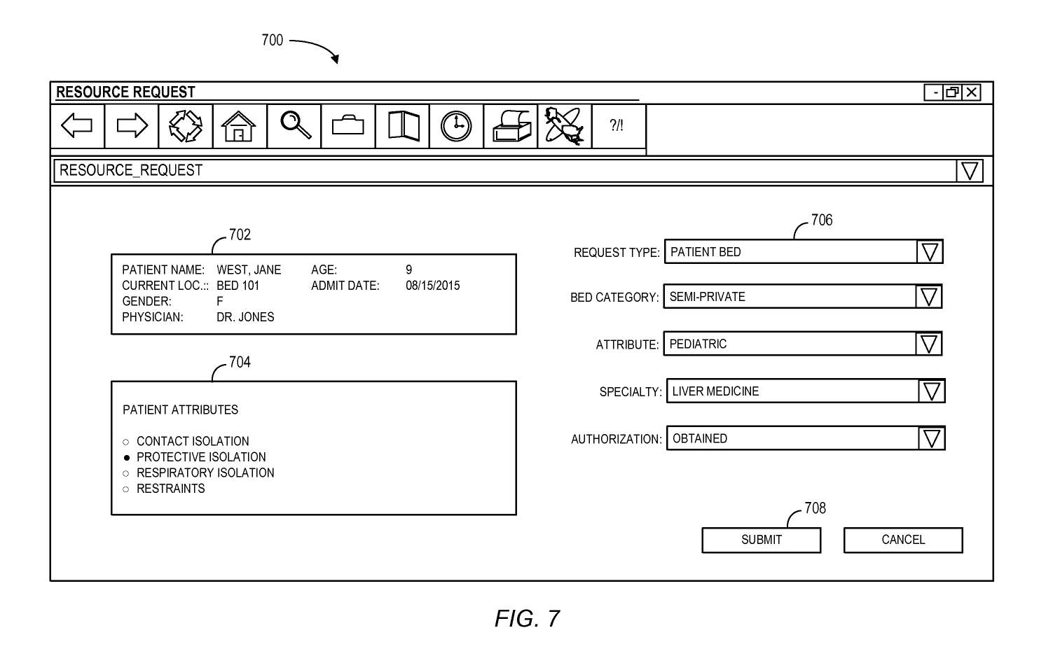

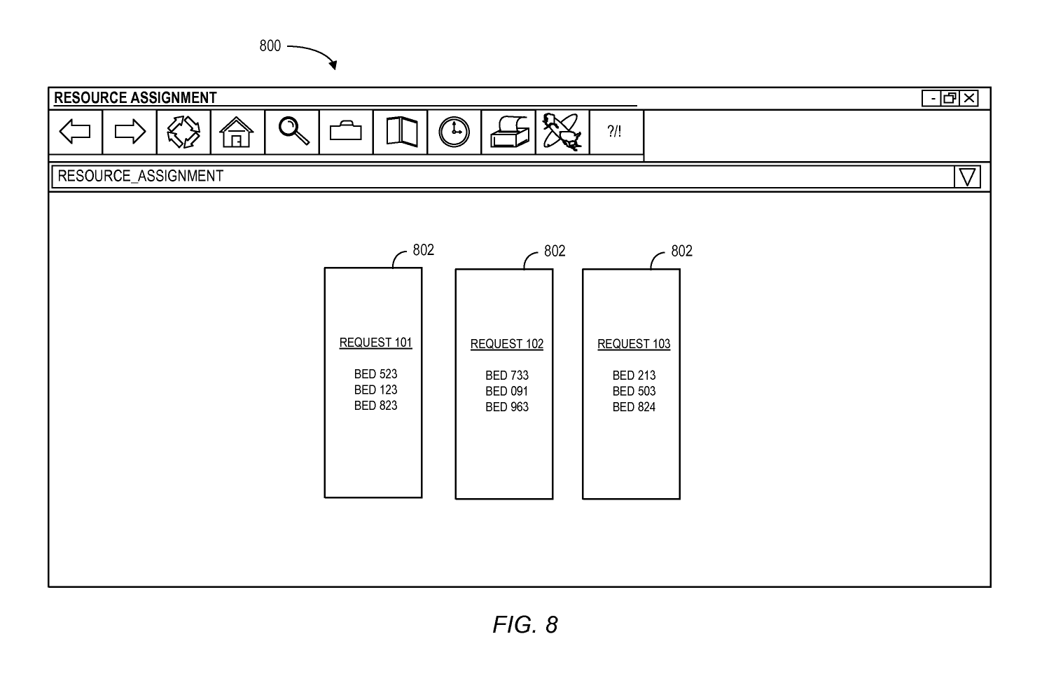

At S240, a resource request is received. The resource request might comprise, for example, a request for a patient bed that is entered into the system by a nurse via a Graphical User Interface (“GUI”) display such as the one described herein with respect to FIG. 7. At S250, a particular resource is automatically assigned to the resource request based at least in part on the predicted future state of the resources. According to some embodiments, the automatic assignment is output via a GUI display such as the one described herein with respect to FIG. 8. Note that the assignment might comprise a recommendation (to be reviewed by a healthcare provider) or may result in the automatic provision of the resource to the patient.

According to some embodiments, a potential patient flow bottleneck may be automatically detected by the healthcare enterprise simulation model. For example, the model might detect that too many patients are going to be assigned to a particular medical unit. In this case, resource assignments may be automatically selected and/or revised to avoid such a bottleneck.

According to some embodiments, the predicted future state of the resources at a particular time may be automatically compared with the actual state of the resources at that time. For example, a predicted number of available patient beds a 5:00 PM might be compared to the number of beds that were actually available at that time. Moreover, based on a result of said comparison, the healthcare enterprise simulation model and/or an assignment algorithm might automatically adjusted (e.g., to improve the performance of the model and algorithm).

According to some embodiments, the healthcare enterprise simulation model is parametrically driven and hot started based on the current hospital state. Moreover, possible alternative future states of the hospital may be predicted for upcoming work shifts to provide early visibility into potential resource bottlenecks (e.g., bed shortages) and proactive potential alternative assignments may be provided to avoid or minimize the impact of such bottlenecks. Mitigation alternatives might include, for example: the timely discharge or transfer of patients; adjustments to housekeeping and patient transport priorities and staffing decisions to improve patient flow; nursing level decisions in view of patient care requirements; bed assignment modifications and/or changes in priorities for patients to be admitted; clinical order prioritization adjustments for labs, imaging facilities and pharmacy units; changes to scheduled surgeries; and/or emergency room diversions.

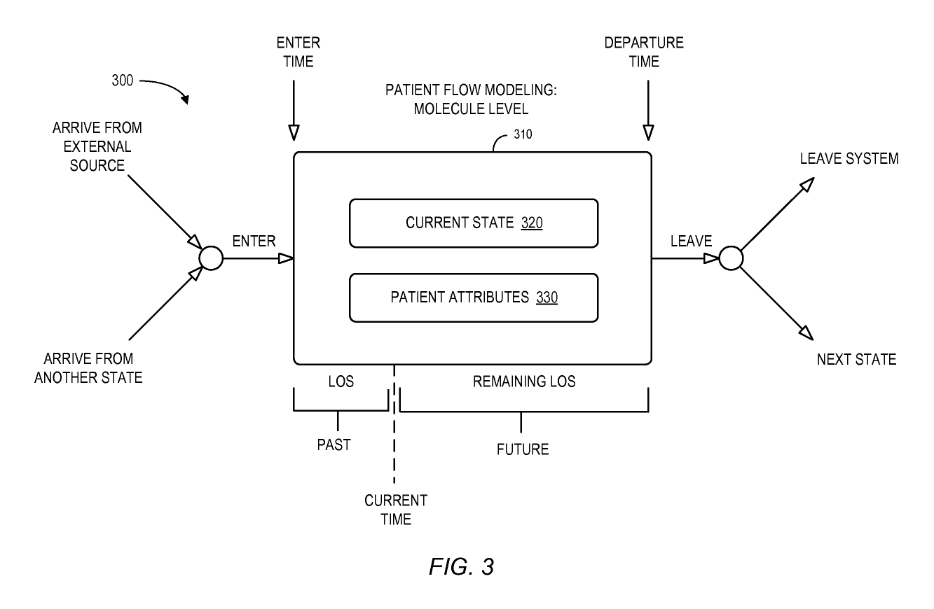

FIG. 3 illustrates a patient flow model 300 at a “molecule” 310 level according to some embodiments of the present invention. Note that the future state of a complex throughput system may be based on the current state of the system, future known events, future events predicted by history, and/or a transfer function representing the system's behavior. At any given point in time, a patient may be in a current state 320 where there is either a care activity or a wait/delay state for the next care activity to begin. For example, a patient can be either in a surgery or waiting in the holding area for the operating room and the necessary resources to become available. The patient enters into this current state 320 from either another state or an external source. For example, the patient may arrive into an Emergency Department (“ED”) via ambulance to be triaged by the nurse to assess his or her acuity level or may arrive into the Post Anesthesia Care Unit (“PACU”) area after a surgery is completed (e.g., where there is a bed and nurse available to help the patient recover from the anesthesia). External arrivals to the system might be driven by historical patterns of volume based on the time of the day or by schedules, such as patients who schedule surgeries in advance.

Regardless of how a patient arrives at the current state 320, there may be an entry and departure time associated with the current state 320. The Length Of Stay (“LOS”) in the current state 320 is the difference between the “current time” and the “entry time” to the state. How long a patient stays in the current state 320 may be based on many factors including pre-determined fixed time durations, patient attributes 330 (e.g., his or her acuity level), primary diagnoses, care activity times that have random distributions, availability of resources needed to perform the required care activity, and/or the dynamics of the system (e.g., the readiness of a next state to accept the patient with bed and/or nurse availability). The model may have a transfer function with the proper fidelity to “predict” the remaining LOS in the current state 320 by a patient.

In general, there are two possibilities for the next destination or state when the patient is ready or allowed to leave the current state 320: departure from the throughput system or entry into a next state (e.g., for queuing or additional care activity). The next step decision might be based on historical patterns (e.g., ED patients have 83% chance to be discharged or a 17% chance to be admitted) or based on a rule or condition (e.g., surgical patients must go to a PACU area for recovery). If the next state is not an exit, there may be a single or multiple possible next states (locations). In the case of multiple possible next states, the choice may be random (driven by historical patterns) or may depend on a rule. For example, for ED patients to be admitted into an inpatient unit there might be a set of specific units with a preferred order. If no space is available in any of those units, there may be less-desired alternatives. If none of those less-desired options are viable, the patient may need to remain in ED until a bed becomes available.

A patient move from the current state 320 to the next state may require additional resources, which may make the move times unpredictable. For example, a patient who must have a Computed Tomography (“CT”) exam performed might need to wait until a transport with a wheelchair becomes available. If the wheelchair is not available, the patient transport may be delayed along with the CT exam process which, in turn, may further delay this particular patient's and other patients' flow through the system. In general, the system resources are limited in number and in resource availability can have a substantial impact on patient wait times and overall system throughput.

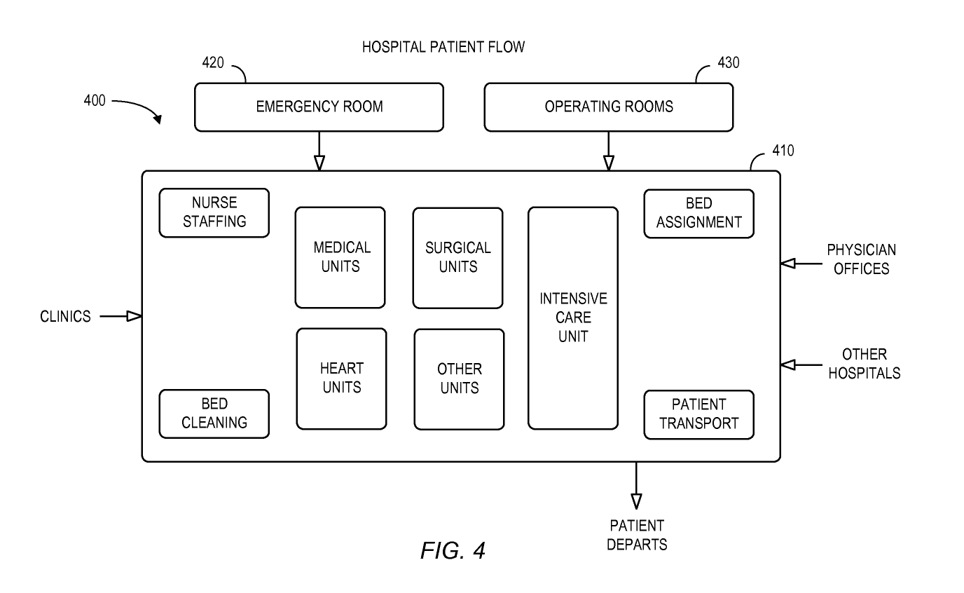

FIG. 4 illustrates a hospital patient flow 400 according to some embodiments of the present invention. The flow 400 includes inpatient services 410 that may receive patients from an emergency room 420, operating rooms 430, clinics, physician offices and/or other hospitals. The inpatient services 410 may include, for example, nurse staffing, bed cleaning, bed assignments, and patient transports associated with medical units, heart units, surgical units, intensive care units, and/or other units.

Such a patient flow 400 illustrates the complexity of a typical hospital system, which involves many linked components and high levels of variability. Note that new patient arrivals may be scheduled or unknown, inpatient services may involve units of varying specialization that typically contain between 12 and 36 beds, and disposition from inpatient units to other parts of the flow 400 or to an external destination. In addition to the flow illustrated in FIG. 4, embodiments might be associated with rehabilitation units, psychiatric units, pediatric units, etc.

Note that patients may be delayed at any step due to capacity restrictions or “workflow” requirements such as surgical or emergency processes. The progress of a patient through the flow 400 may be highly uncertain and small deviations in patient flow can lead to substantial delays across the system if not addressed proactively. Managing patient throughput poses complex operational decisions over time scales from minutes to days. Some examples: whether “swing” capacity should be opened to avoid an upcoming bed-availability crisis; whether unit staffing should be revised to accommodate fewer (or more) patients; the range of admissions (or discharges) that should be expected today in each area and the likelihood that particular areas will be unable to accommodate demand; whether admissions from ED should be re-prioritized versus surgery units; whether some units need priority for bed cleaning or transportation; and/or where pending admissions should be sent in order to minimize potential bottlenecks while still maintaining appropriate levels of care.

The hospital flow 400 presents considerable uncertainty and numerous interdependencies, and a “whole hospital” forecast may address both of these issues and may: reflect system-wide interconnections; incorporate real-time data updates (including current patient status and any capacity or throughput restrictions); be able to model potential alternative tactics as well as “typical” behaviors; and/or avoid use of clinical health information. According to some embodiments, a system level discrete event simulation based on patient level data may be provided in connection with resource assignments.

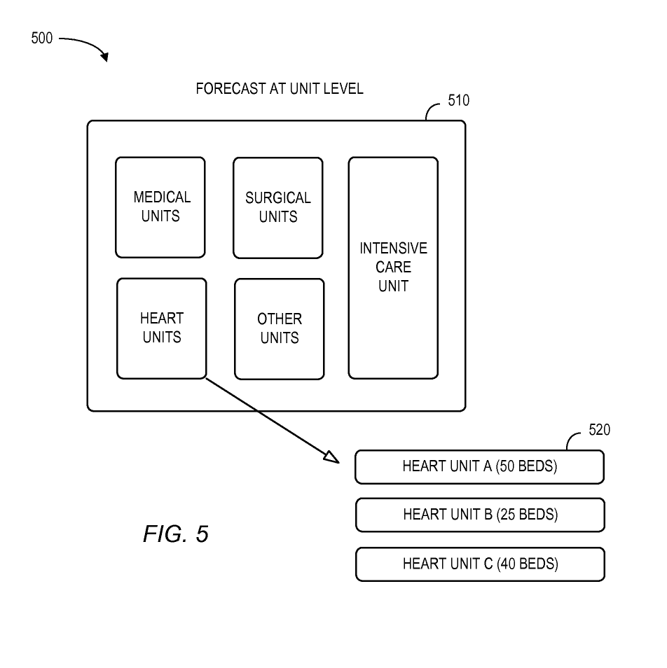

Note that each of the units illustrated in the hospital patient flow 400 may itself comprise a number of units. For example, FIG. 5 illustrates a unit level forecast 500 according to some embodiments of the present invention. In particular inpatient services 510 includes a heart unit which itself is composed of heart unit A (50 beds) 510, heart unit B (25 beds), and heart unit C (40 beds). A healthcare enterprise simulation model may receive current resource data for and/or make resource predictions for each of these units 510.

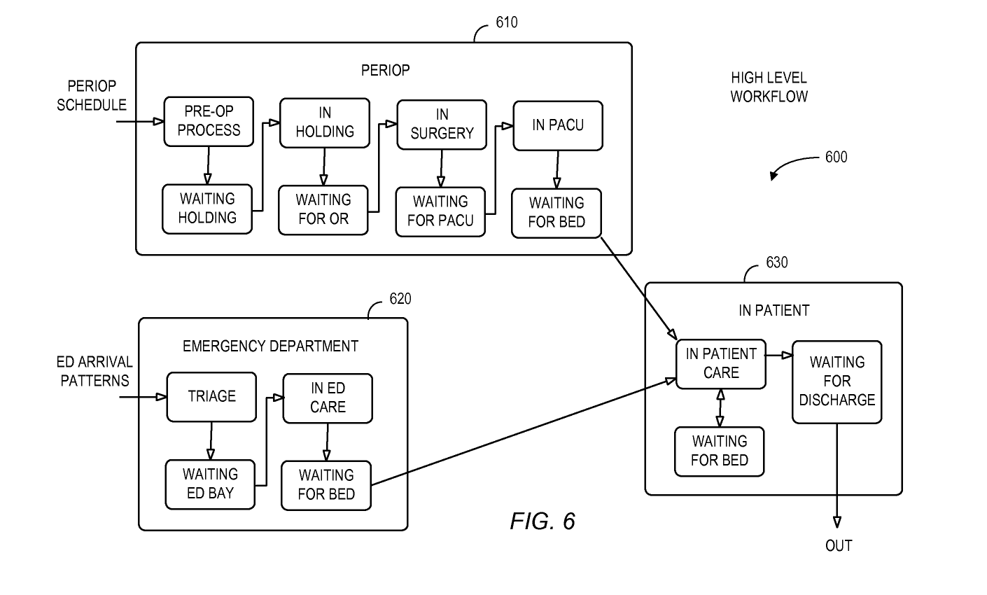

FIG. 6 illustrates a high level workflow 600 according to some embodiments of the present invention. Note that the molecule 310 described with respect to FIG. 3 may comprise a building block for an overall patient care delivery throughput system. Moreover, the workflow 600 includes a perioperative area (“PERIOP”) 610 for surgical patients, an emergency department 620, and inpatient services 630. Other sources of patients might include a catheterization laboratory for heart patients, direct admits from the physician offices, and/or transfers from other hospitals.

The inpatient services 630 units might represent locations where a patient spends at least one night in the hospital in order to go through the care plan appropriate for his or her treatment. The patients who are medically ready to leave the hospital are “discharged.” Sometimes a patient may be “transferred” to another inpatient services 630 unit to continue their care process.

Note that surgical patients are usually scheduled in advance. However, sometimes unscheduled surgeries (e.g., due to an emergency) are added to the schedule with little advance notice and this may impact the flow of scheduled patients. A surgery may require a patient to be admitted to an inpatient unit or a patient may be discharged after the surgery. The high level steps for surgery patients may include pre-operation activities to prepare the patient for the surgery, a holding stage where additional exams by the surgeon, nurse and the anesthesiologist may be conducted, the operating room where the actual surgery takes place, and a recovery room PACU to assure that the patient is medically ready to move on. At any given time, a surgical patient may be in any one of these value-added stares or may simply be waiting for the resources or capacity (staff, equipment, room, etc.) to become available.

Patient arrivals to the ED are usually unscheduled. The first step is usually a triage activity to prioritize the care needed based on the patient's acuity level. Once the triage and the registration processes are completed, the patient waits until there is a room/bay available for the assessment and treatment. Due to random arrivals and dynamic acuity levels, the patient's priority may change frequently as new patients arrive into the system. Once a space becomes available, several nursing and physician assessments are conducted, clinical orders (lab, imaging, etc.) may be placed and fulfilled, and eventually a disposition decision is made whether to admit or discharge the patient.

The level of detail needed to accurately represent the real system and to predict its capacity in the future depends on the data availability and the objectives of the prediction capability. Some embodiments described herein provide a flexible, scalable and generic capability to model the transfer function properly. Moreover, some embodiments may leverage a generic, data driven, parametric simulation modeling toolkit to model complex hospital operations by taking into consideration the interdependencies and the randomness contained therein to provide appropriate resource assignments.

FIG. 7 illustrates a resource request display 700 according to some embodiments of the present invention. The display 700 might include a patient information area 702 that is automatically pre-populated with information about a patient associated with the resource request. The display 700 may further include a patient attribute area 704 that can be used by a healthcare professional to help define the resource request (e.g., by indicating that the particular patient will need a patient bed that provides protective isolation). The display may further include a request information area 706 that can be used to define a request type, bed category, bed attributes, etc.

Upon selection of a submit icon 708, the system may process the resource request using one or more assignment algorithms and generate a resource assignment for the patient. For example, FIG. 8 illustrates a resource assignment display 800 according to some embodiments of the present invention. The display 800 includes one or more patient bed identifiers 802 for one or more resource requests. When more than one patient bed identifier 802 is provided for a request, the identifiers 802 may be ranked from most preferable to least preferable.

According to some embodiments, the resource assignment algorithms used to assign the 802 may be based on a simulation model and/or a current state of hospital resources. For example, a real time hospital information aggregator may receive data from hospital information systems and/or Real Time Location Systems (“RTLS”) about equipment, patients, and/or staff. The hospital information systems might include, for example, Admission Discharge Transfer (“ADT”) for inpatient, departmental systems for ED, PERIOP, a catheterization laboratory, ancillary systems for Lab, Pharmacy and Diagnostic Imaging (“DI”), scheduling systems for surgery, imaging, medical procedures, and financial systems (e.g. for billing).

The data from the hospital information system may, according to some embodiments, also be used to extract information to characterize the hospital and its historical behavior. Automated data mining and knowledge extraction methods may be used to define, store and translate this information into a usable form for the hospital system transfer function and/or assignment algorithms. Typical information includes the names, location and the capacity for patient care units including the ED, PERIOP, intensive care units, where the required care is provided to the patients at this specific hospital as well as the processes and the resources required to deliver a specific type of care. The historical information for patient arrival volumes and patterns, process times, disposition probabilities, and discharge and transfer patterns and volumes may also be extracted from the data in order to be able to execute the operations of the molecule 310 structure described with respect to FIG. 3. All of this information may be periodically updated and stored by a hospital configuration and historical information component in a database for modifications if and when necessary. In order to make this information usable by the hospital transfer function, a configurator routine can be executed to automatically build the model and populate the necessary tables that parametrically drive the model.

The model generation may comprise a one-time event for a particular site even though modifications to the structure and data may later be made to match the real-system evolution. An automated analytical workflow may drive the operational decisioning cycle which starts with an automatic capture of the current state. This real time information may include data such as patient location, workflow state, bed and resource availability, queue information, etc., and “scheduled” activities for surgery, external patient arrivals, etc. After being obtained, this information may be automatically processed for a simulation model and placed in a database for running simulation replications. Once the multiple replications are executed, the automated analytical workflow may distill the simulation output, perform the analysis required to forecast hourly bed availability/occupancy for each care unit/service/whole hospital and use this information to automatically generate an appropriate resource assignment.

Depending on how the system is set up, the simulation analysis may take place either in a cloud environment or on premise at the hospital. The system may, according to some embodiments, host certain analytical workflow steps on premise and other steps in a cloud.

Real-time input data might be obtained, for example, from an AgileTrac™ system available from GENERAL ELECTRIC CORPORATION® which has interfaces to multiple hospital information systems and databases. According to some embodiments, data may be provided as encrypted descriptions the current state of all beds, patients, surgical cases, and bed requests across the hospital. Only a small subset of the data available in each source might be actually extracted to avoid use of private health data. Specific sources for current resource data might include: an ADT database (indicating location, entry time and current status of each patient); surgical schedule, covering planned procedures and case start/end types; surgical workflow status, which tracks patient progress through various stages such as Pre-Op, Operating Room (“OR”) and recovery; bed requests (admission orders) for current and pending patients, listing basic needs such as specialty (orthopedics, cardiology, etc.), wait times and other criteria; discharge orders, indicating whether pending or confirmed and time order was written; and/or a bed board listing each inpatient bed and its current status (e.g., occupied, available/clean, available/dirty, cleaning in progress, blocked or otherwise out of service).

Note that data processing, simulation runs, and post-processing may be conducted on a dedicated secure server. Resource assignment reports may be generated and sent via e-mail to a configurable distribution list, and also encrypted and transferred to a cloud-hosted service for a controlled set of users to view on password-protected web pages. According to some embodiments, outputs are used to create different types of displays and reports for specific audiences.

As part of initial system set up for a new facility, the hospital's capacities, patient pathways across locations, and care types may be determined. The initial set up may be performed manually, utilizing historical patterns extracted from a AgileTrac™ data or any other hospital information system database archive including durations for length of stay in various units and care types, dispositions for patient movement between units, volumes of unscheduled arrivals, and variances within workflows. According to some embodiments, generating such patterns may be manually performed (e.g., by running a set of pre-defined SQL queries on a particular date range of historical data). According to other embodiments the generation of these patterns is automated.

The data mining for care pathways may be performed on a “first-principles” assumption that there are a limited (and known) number of paths by which patients can enter and exit each location. Some embodiments systematically extract the appropriate patterns and probabilities for each path based on the specific interconnections of a particular hospital's simulation model.

All inpatient units may be updated with a current number of potential beds by computing the total bed count and subtracting any blocked (out of service) beds. Each current and scheduled patient may, for example, be placed into one of 50 categories based on the data types present for them, which guides their specific care path. Each patient's category may be used to apply stochastic parameters and generate 100 replications (potential future paths) for that patient. Note that a resource assignment may be generated relatively quickly (e.g., within five seconds of receiving a resource request).

The simulation model may place patients in their current locations with pre-elapsed stay durations (rather than the model beginning with an empty hospital), followed by adding future known/scheduled events such as planned admissions or surgical cases, and probabilistically-generated unscheduled arrivals of various types. 100 replications may be generated for all current patients as well as for future events and unscheduled arrivals, covering volume, arrival timing, and movement paths through the system. The model may be associated with a generic and parametrically driven discrete-event simulation construct built on an AnyLogic™ or any other simulation platform (which might requires little re-coding to accommodate different hospitals or care pathways).

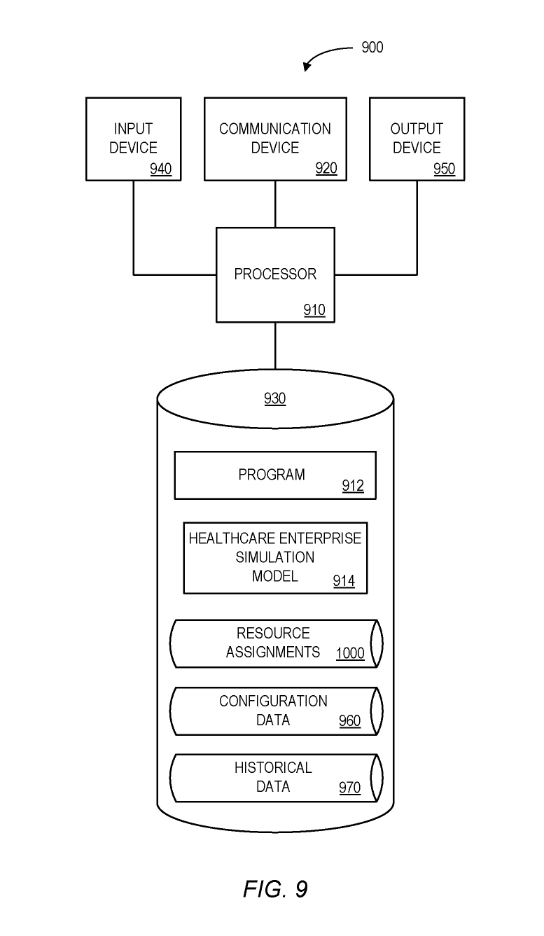

The embodiments described herein may be implemented using any number of different hardware configurations. For example, FIG. 9 is block diagram of a tool or platform 900 that may be, for example, associated with the system 100 of FIG. 1. The resource assignment platform 900 comprises a processor 910, such as one or more commercially available Central Processing Units (CPUs) in the form of one-chip microprocessors, coupled to a communication device 920 configured to communicate via a communication network (not shown in FIG. 9). The communication device 920 may be used to communicate, for example, with one or more remote devices (e.g., to receive current resource data). The resource assignment platform 900 further includes an input device 940 (e.g., a mouse and/or keyboard to configure a healthcare enterprise simulation model) and an output device 950 (e.g., a computer monitor to display resource request and/or assignment displays and associated reports).

The processor 910 also communicates with a storage device 930. The storage device 930 may comprise any appropriate information storage device, including combinations of magnetic storage devices (e.g., a hard disk drive), optical storage devices, mobile telephones, and/or semiconductor memory devices. The storage device 930 stores a program 912 and/or a healthcare enterprise simulation model 914 for controlling the processor 910. The processor 910 performs instructions of the programs 912, 914, and thereby operates in accordance with any of the embodiments described herein. For example, the processor 910 may continuously and automatically receive current resource data indicative of a current state of resources that are used to deliver healthcare to a plurality of patients associated with a healthcare enterprise. The current resource data may be automatically used by the processor to update the healthcare enterprise simulation model 914. The healthcare enterprise simulation model 914 may be executed to automatically generate a predicted future state of the resources. A resource request may then be received, and the processor 910 may automatically assign a particular resource to the resource request based at least in part on the predicted future state of the resources.

The programs 912, 914 may be stored in a compressed, uncompiled and/or encrypted format. The programs 912, 914 may furthermore include other program elements, such as an operating system, clipboard application a database management system, and/or device drivers used by the processor 910 to interface with peripheral devices.

As used herein, information may be “received” by or “transmitted” to, for example: (i) the resource assignment platform 900 from another device; or (ii) a software application or module within the resource assignment platform 900 from another software application, module, or any other source.

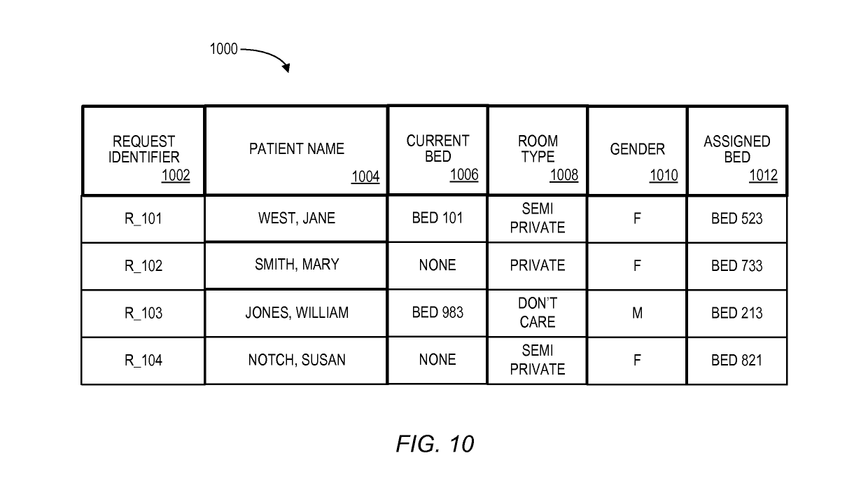

In some embodiments (such as shown in FIG. 9), the storage device 930 further stores a resource assignments database 1000, configuration data 960 (e.g., defining patient flow through the hospital), and historical data 970 (e.g., to predict unscheduled future events). An example of a database that may be used in connection with the resource assignment platform 900 will now be described in detail with respect to FIG. 10. Note that the database described herein is only one example, and additional and/or different information may be stored therein. Moreover, various databases might be split or combined in accordance with any of the embodiments described herein. For example, the resource assignments database 1000, configuration data 960, and/or historical data 970 might be combined and/or linked to each other within the program 912 and/or healthcare enterprise simulation model 914.

Referring to FIG. 10, a table is shown that represents the resource assignments database 1000 that may be stored at the resource assignment platform 900 according to some embodiments. The table may include, for example, entries identifying requests for resources that have been received. The table may also define fields 1002, 1004, 1006, 1008, 1010, 1012 for each of the entries. The fields 1002, 1004, 1006, 1008, 1010, 1012 may, according to some embodiments, specify: a request identifier 1002, a patient name 1004, a current bed 1006, a room type 1008, a gender 1010, and an assigned bed 1012. The resource assignment database 1000 may be created and updated, for example, based in part on information received from resource requests from a healthcare professional and a healthcare enterprise simulation model.

The request identifier 1002 may be, for example, a unique alphanumeric code identifying a resource request received from a healthcare professional (e.g., entered via a display 700 such as the one described with respect to FIG. 7) associated with the patient name 1004 who is currently associated with current bed 1006 identifier. The room type 1008 and gender 1006 associated with the request may be used by a resource assignment engine (along with other information and a simulation model) do determine one or more appropriate assigned bed 1012 identifiers. Note that a particular resource assignment for a particular patient might be influenced by other resource requests associated with other patients (to improve the flow of patients through the hospital).

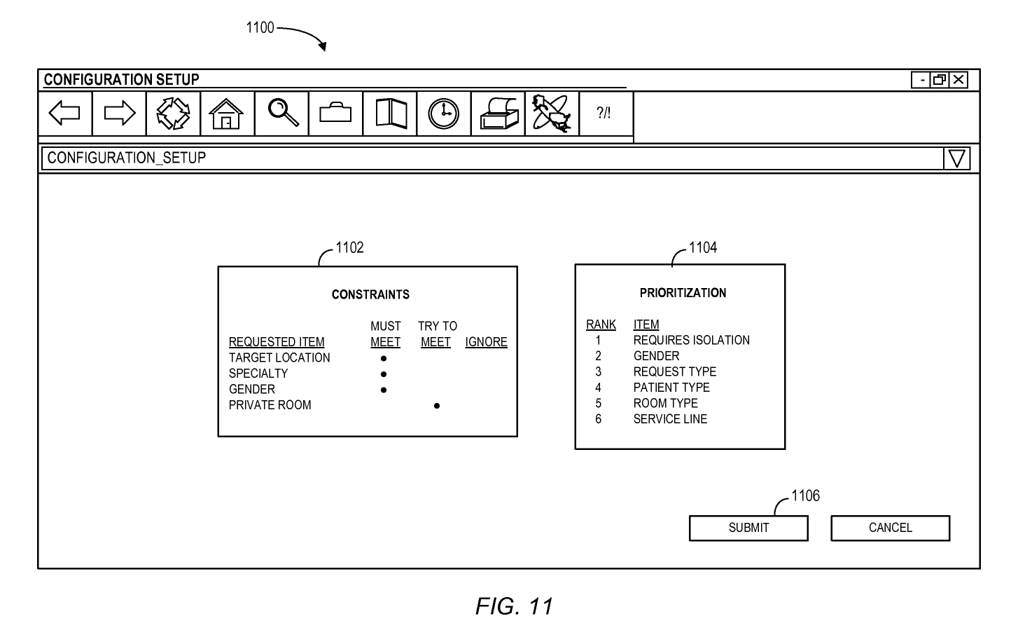

Thus, embodiments described herein may provide automated resource and patient flow management. Note that different hospitals may have different requirements and/or priorities when determining resource assignments. According to some embodiments, configuring a resource assignment engine may include defining a plurality of goals, and, for each defined goal, a level of importance may be assigned to that goal. For example, FIG. 11 illustrates a configuration setup display 1100 in accordance with some embodiments. The display 1100 includes a constraint entry area 1102 where an administrator can indicate if various requested items (target location, specialty, gender, etc.) should be considered a requirement that resource assignment engine must meet, should try to meet, or may be ignored. The display also includes a prioritization area 1104 where the administrator can define a ranked list of items, from highest priority to lowest priority. When this information is finalized via a submit icon 1106, the resource assignment engine can use the data to adjust resource algorithms as appropriate. According to some embodiments, a mathematical programming approach, such as a mixed integer approach, may provide flexible modeling and user configurable constraint management. Moreover, problem sizes may be reduced by removing infeasible beds (pruning) and reducing the number of integer variables resulting in reduced solutions times.

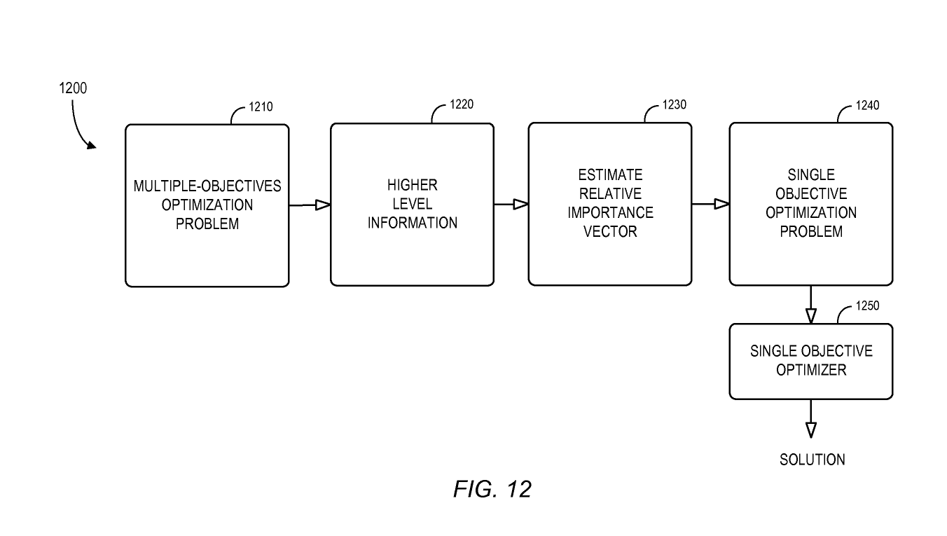

FIG. 12 illustrates a bed assignment model 1200 that might be provided according to some embodiments. Initially, a multiple objectives optimization problem 1210 may be defined to maximize benefits and/or minimize penalties with respect to various constraints. For example, a base assignment benefit, a request type benefit, an inpatient status benefit, originating location benefit, wait time penalties, and/or mismatch penalties might be considered. Higher level information 1220, such as entity ranking, may be used to estimate a relative importance vector 1230 for the problem. For example, an importance vector of (w1, w2, . . . wn) may be estimated using priority ranking information. As a result, a single objective optimization problem 1240 may be defined, such as a composition function F=(w1 f1+w2 f2+ . . . +wn fn). A single objective optimizer 1250 may then output an appropriate solution (resource assignment) for a given importance vector.

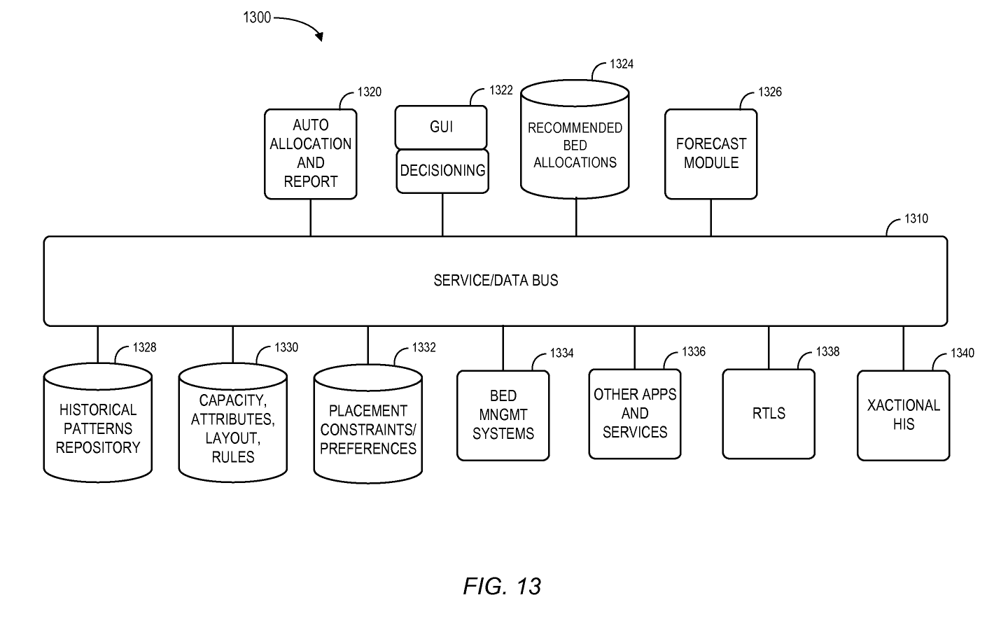

FIG. 13 illustrates a reference architecture 1300 that might be provided according to some embodiments. A service/data bus 1310 may allow for communication between various components, such as an automatic allocation and report element 1320 (e.g., to output a current automatic bed assignment decisioning and state report) and an automatic bed assignment decisioning element and associated GUI 1322 (e.g., to refresh, allocate, modify, buffer, synchronize, and/or optionally commit resources). A recommended bed allocations database 1324 may store the assignments and a forecast module 1326 may be used to predict future resource states and/or bottlenecks. A historical patterns repository 1328 may be used to configure the forecast module 1326 and a capacity, attributes, layout, and rules database 1330 may define how the reference architecture 1300 should allocate resources based on information in a placement constraints and preferences database 1332. One or more bed management systems 1334 may be used to implement the assignments. Other applications and services 1336 may be support, such as automatic messages reflecting the assigned resources. A Real Time Location Service (“RTLS”) element 1338 and/or transactional Hospital Information System 1340 may provide information about the current state of hospital resources.

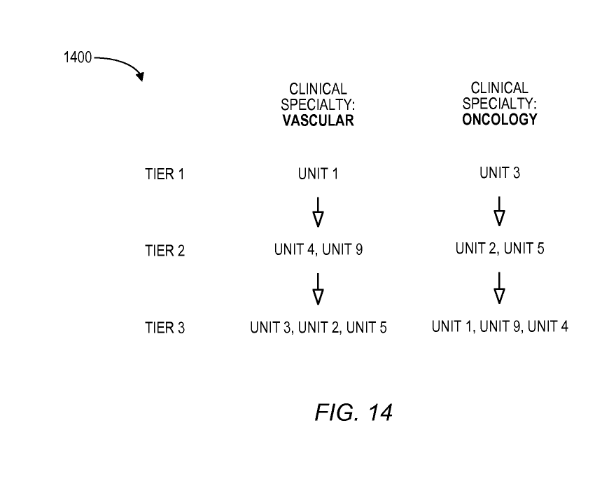

Note that a goal of automated bed assignment may be to assign patients in a way that improves the utilization of beds and other hospital resources while meeting patient care and flow requirements. In a hospital, units may be grouped by services lines (e.g., broad categories of healthcare such as heart, surgical, etc.) and further classified into subgroups based on clinical specialties (e.g., branches of medical science that specialize in the treatment of specific disease types). Although a unit of a certain clinical specialty may be best suited for a given patient, other units may also be able to accommodate the patient if beds in the preferred unit are not available. According to some embodiments, every unit may be assigned to a “tier level” representing a multi-level ranking and ordering of units in a decreasing order of preference. For example, FIG. 14 illustrates a tier structure 1400 that might be provided in accordance with some embodiments. The tier structure 1400 depicts the suitability of inpatient units in a multi-level ranked order for meeting patient care needs based on a given medical specialty.

Note that beds may be placed into rooms of different types: private, semi-private (e.g., with two or more beds) and VIP rooms. Moreover, each bed may possess different attributes such as telemetry, a step down feature, stroke, epileptic, laminar air flow, etc. Bed requests may encompass several types based on the origination of the request and the function that needs to be executed. For example, requests may be made to transfer inpatients between inpatient units, from post-surgical recovery to a unit, from emergency treatment to inpatient units, or from another hospital to an inpatient unit. The actual type of bed needed by a patient may depends on clinical and non-clinical attributes associated with the bed request. Clinical attributes such as telemetry order may be influenced by a physician's decision making for best clinical outcome, patient safety, and enhanced quality of care. Non-clinical attributes, such as a patient's desire for room with amenities, may allow for convenience, comfort, and improved monitoring. Bed managers may seek to match the attributes of a bed request with those of the beds that are available (or will become available in the near future).

According to some embodiments, bed assignments have to meet a number of patient care and resource utilization requirements that are modeled as constraints in a math programming problem. A bed request may specify the attributes of the bed that are needed for the patient. The suitability of a bed to provide adequate care for the patient is determined by the exact matching of specified attributes. Bed managers require that the patients with a given medical service are placed in units that belong to their respective service lines. In addition, a maximum tier level 1400 for every clinical specialty may be specified by the bed managers when assigning patients to beds. The maximum tier level 1400 specified can also be dependent on the time of the day. Some embodiments may help ensure that the patients are placed in units that belong to a tier level that is less than the maximum specified level for a given clinical specialty. Bed requests may also specify the type of rooms needed by patients and in some embodiments patients are also placed in the specified room type. If a patient needs isolation, for example, it may be required that the patient is not placed with other patients. Another requirement of a hospital may be to avoid a mismatch of patient genders in semi-private inpatient rooms. It may also be important from a patient care perspective to ensure that bed assignments within a unit do not exceed a specified nurse to patient ratio.

This type of bed assignment problem may be formulated as a mixed integer goal program, as follows:

Maximize
a weighted sum of benefits obtained from assigning patients to beds with penalties for deviating from hospital requirements/goals

Subject to
hospital requirements/goals constraints (these can be hard or soft constraints based on user preferences); meet service line requirements; meet target unit requirements based on physician preference for placements; meet tier requirements; meet room type requirements; meet gender mismatch requirements for semi-private rooms; match the request attributes with the bed attributes; avoid assigning patients to beds with attributes not requested; avoid use of inpatient beds which are physically occupied by clinically discharged patients; maintain stability of the solution as dynamic events occur in the system; meet staff to patient ratio requirements; and meet unit utilization requirements
with the following Hard Constraints a bed is assigned to only one patient; a patient is assigned to only one bed; and meeting patient isolation requirements

An objective of the resource assignment problem may be to maximize the benefits obtained from assigning patients to bed less the penalties incurred in not meeting the hospital requirements/goals. In some embodiments, base benefits may be realized when a bed request is fulfilled. These benefits are increased based on the request type, patient type and unit originating the request. For example, it may be more beneficial to move a patient out of Intensive Care Units (“ICU”) into an inpatient unit quickly so that scarce ICU beds will be available for more acute patients waiting for a bed. Benefits are also realized depending on how long a request has been waiting to be fulfilled, and if the unit originating the request is blocking patients waiting to get into the unit due to lack of bed availability. The relative importance of various benefits from the bed assignments may be ascertained from the weights for benefit parameters based on user preferences. Note that an important aspect of bed assignments may be to reduce congestions at hospital and unit entry points to maintain smooth patient flow.

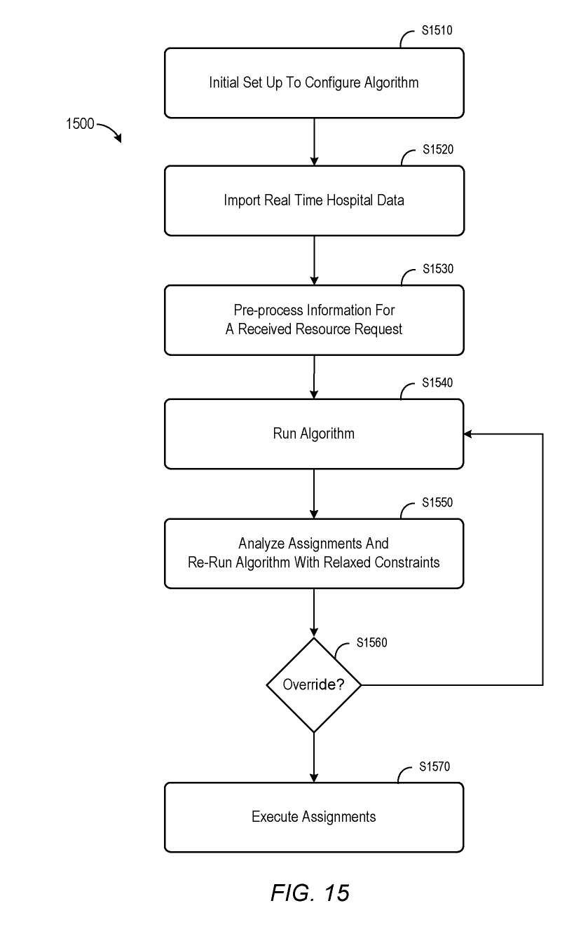

FIG. 15 illustrates a method 1500 that might be performed in accordance with some embodiments. In particular, an algorithm in a decision support system may be used to obtain actionable solutions to the bed assignment problem. At S1510, an initial configurations up may be performed to establish an algorithm that will be used to automatically assign resources. According to some embodiments, hospital requirements are modeled as goal constraints. A constraint in the model can be setup as either a hard or soft constraint based on the hospital user preferences. If the user specifies a certain constraint to be a soft constraint, then the assignment engine may associate a slack variable with the constraint to model the extent of deviation from the goal. Depending on the type of constraint, a linear or constant penalty function may be used in the model. These penalty functions may be applied to the slack variables in the objective function.

The service line constraints may ensure that patients with a particular medical service are assigned to beds in their respective service lines. The target unit constraints may ensure that patients are placed in the physician preferred unit as specified by the request. The tier constraints may ensure that patients are placed in a unit that belongs to a tier less than the maximum level specified. The room type constraints may ensure that patients are placed in the requested type of rooms. The isolation constraints may ensure that patients with isolation requirements are placed in private/VIP or empty semi-private rooms. The attribute constraints in the model may ensure that patients are assigned to beds that have all the requested attributes. The attribute constraints in the model may also, according to some embodiments, ensure that patients are not assigned to beds with extra attributes that were not requested. The gender mismatch constraints may ensure that all patients assigned to the same room have same gender. The nurse to patient ratio constraints may ensure that bed assignments to a unit meet the required nurse to patient levels. The unit utilization constraints may ensure that beds in a unit are fully utilized before considering assignments to an empty unit. The discharge constraints may ensure that patients are not assigned to beds with other patients who are clinically discharged but still physically occupying the bed. Note that the constraints in the model might not be of equal importance. The relative importance of each constraint set in the model may be ascertained from the weights for penalty parameters based on user preferences. A rating scale method may be used to extract user preferences and determine the weights for benefit and constraint parameters. Moreover, the hospital structure (such as details of units, rooms, beds, attributes etc.), mappings (unit to tier relationships etc.) relevant hospital requirements/goals, constraint types (such as hard or soft), benefits, penalties and weight parameters may be then be stored a configuration database at S1510.

At S1520, current resource data is collected from real time data gathering and workflow systems. The real time information might include bed requests, bed status, patient information, and/or patient location and patient workflow status in collected from the hospital system. After the data is collected, a list of beds along with their bed status may be prepared. This list may be further classified into beds that are unavailable, clean and available, in the process of being cleaned, and those that are occupied by clinically discharged patients. The system may also collect real time information on patients in occupied beds and current staffing levels in the units.

At S1530, the gathered current resource information may be pre-processed in connection with a received resource request. For example, the system may preprocess the data to reduce the size of mixed integer programming problem. To reduce the size of the problem, the algorithm may prune a number of variables using constraint satisfaction techniques. For each request, the suitability of a bed, room and unit might be established. The algorithm may then sequentially check for violation of independent constraints (such as a gender mismatch in a half occupied semi-private room). If a bed is not suitable for a request during the preprocessing stage, it may be from consideration for that request in the model. Such pruning reduces the number of variables in the optimization model. The resulting problem may still have thousands of variables but can be solved using existing math programming solvers within a reasonable amount of time. At S1540, the algorithm may be run to solve the math programming model.

At S1550, the assignments generated by the algorithm may be analyzed to decide whether or not an automated rerun of the model with relaxed constraints is needed. For example, after obtaining the solution to the math programming problem, the system may analyze the solutions obtained by the algorithm to check if there are bed requests that could not be fulfilled. The system may then automatically relax the target unit and tier constraints at S1550 and rerun the model after excluding the beds which have already been assigned to requests. The assignments resulting from model rerun may serve as alternative assignment recommendations. Note that alternative recommendations may still meet all clinical requirements while dropping certain preferences or hierarchies.

At S1560, a healthcare professional might override the assignment and choose a different bed than the one suggested (since he or she might have more information about a particular request that is not reflected in the system). If so, the algorithm might be re-executed at S1540 in view of the override or the process may simply end. At S1570, the assignments may be executed and the automatically assigned resources may be provided to patients.

Note that various portions of the method 1500 might be performed locally at a hospital and/or remotely via a cloud-based service. For example, FIG. 16 illustrates a cloud based bed management approach 1600 including both elements located at a hospital 1610 and at a cloud platform 1620. According to some embodiments, a hospital's data center 1614 may provide information via an encryption process 1644 to a data layer 1630 of an automated bed assignment service at the cloud platform 1620. The cloud platform 1620 may include, for example, infrastructure 1628 (containing the applications for developing, hosting and managing software applications), applications 1626 (e.g., workflows for executing the bed assignment algorithm which includes data input, model setup, algorithm run and data output along with synchronization of the data held within the algorithm and the data layer 1630), and/or security elements 1622 (to monitor compliance of end user access and data privacy). The cloud platform 1620 may also include a presentation layer 1622 to exchange information with a personal computer 1612 at the hospital 1610 via a decryption process 1642.

According to some embodiment, a bed assignment solution may be hosted as a cloud application for access through an interactive web based user interface. Moreover, reporting and dashboard capabilities may be provided to help hospital leadership benchmark, measure, and improve hospital operations. The cloud based deployment may reduce the infrastructure requirements on a hospital and provide hospital personnel with instant access to resource assignments. To protect sensitive data stored and accessed from the cloud the encryption process 1644 and decryption process 1642 may be utilized. Note that implementing an automated bed assignment application on a cloud platform may enable transportability of the system across different platforms and/or hospitals.

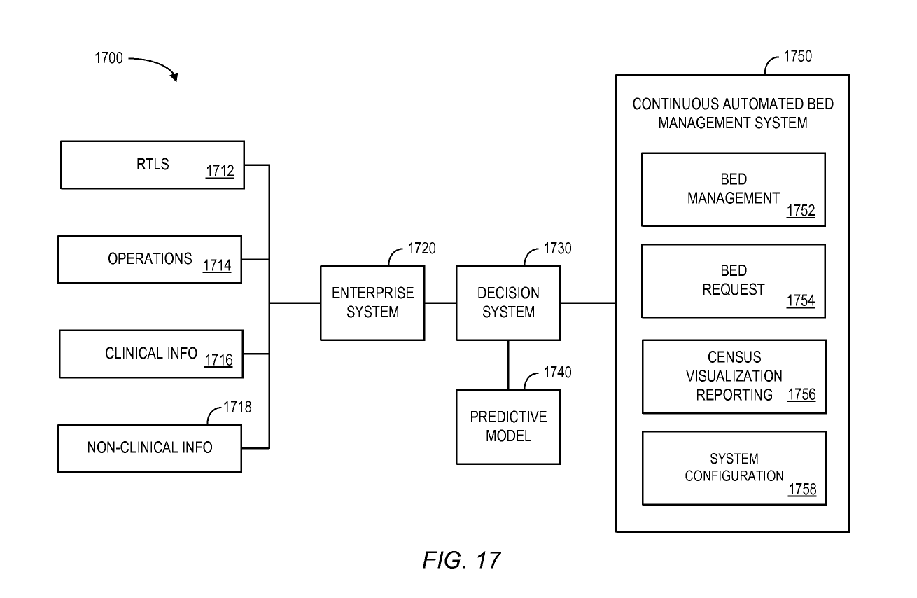

Note that embodiments of the present invention may be implemented in any number of different ways. For example, FIG. 17 is a system diagram for a continuous automated bed-patient management system 1700 in accordance with some embodiments. The system includes operational elements, including a RTLS 1712. The RTLS 1712 may, for example, incorporate patient and/or staff wearable tags designed for cost-effective healthcare tracking solutions. Equipment tags may be securely attached to any equipment using fasteners or commercial adhesive. According to some embodiments, the RTLS 1720 may include a sensor network and an information network.

The sensor network may be a mesh network that consists of sensors that constantly tracks the location of a tagged item. The sensor network could use a multitude of technologies such as Wi-Fi, active and passive Radio Frequency Identification (RFID), Infrared (IR), and/or Ultra-Wideband for real time tracking. The information network may include a bridge that connects the sensor network to the hospitals network, location servers that compute the location of the tagged items in spatial coordinates and transmits that information to a tracking/display system.

A multi-resource management system 1700 may help optimize the use of clinical and non-clinical staff and equipment to provide quality care to patients and improve patient flow. The system 1700 may allow interacting units to schedule services for inpatients based on received orders and improve visibility and communication throughout a hospital. In addition to the RTLS 1712, the components of multi-resource management system 1700 may include, at an operations level, an operation system 1714, a clinical information system 1716, and a non-clinical information system 1718. These operations level components may communicate with a decision system 1730 via an enterprise system 1720. The decision system 1730 may then exchange information with a continuous automated bed management system 1750 to facilitate resource assignment and scheduling outputs, staff schedules and assignments, equipment schedules and assignments, and inpatient itineraries along with schedules based on service requests.

The operations system 1714 may manage information about the front office and back office operations of a hospital, such as appointments, billings, logistics, etc. The clinical information system 1716 may manage information about the clinical aspects of the patients, such as diagnostics, medical records, blood bank, etc. The non-clinical information system 1718 may manage information about the non-clinical aspects of patients in the system, such as patient itinerary, patient requests, patient resource management, etc. The enterprise system 1720 may manage the financial and management aspects of the hospital, such as budgeting, areas of specialties, etc. The decision system 1730 may help with all aspects of decision making and analytics within the hospital such as staffing, scheduling, assignments, and logistics.

The system 1700 may implement bed-patient and/or nurse-patient assignment methods to improve patient care and patient flow through the system. Although the system 1700 can be used to management many different types of resources, an example of “patient bed” management will be provided in detail. In particular, a bed request function may be used during a pre-admission process prior to a patient's arrival. The request begins with an open status which includes data collected from an admissions process as well as user-entered data on a bed request form (e.g., about patient clinical and nonclinical attributes and requests). A transfer request function may be used after the patient is admitted and he or she is placed in a bed. A bed transfer may occur when a temporary allocation is made or if the patient attributes change over time. Note that patient beds may be associated with a room type (e.g., private, semi-private, deluxe, and negative air pressure rooms). Moreover, the attributes of the patient requesting a bed are based on clinical and non-clinical requirements associated with the patient. Some examples of patient attributes are gender, disease category, room type, isolation, and patient condition.

The decision system 1730 may consider a decision time horizon and/or a time interval selected by analyzing the arrival rate of requests in the system. Appropriate handling of patient flow issues may require timely fulfillment of beds, transfers, and adequate staffing levels in units. A bed management module 1752 of a continuous automated bed management system 1750 may work to meet several desired patient flow goals hence may rank the goals depending on preference. Weights may be associated with these ranking of goals.

An objective function may be expressed as a weighted sum of violations of hard and soft constraints. The objective is to minimize the weighted penalties for deviating from the ideal bed for patient and penalties for deviating from desired patient flow objectives. Examples of “hard” constraints may include: a bed with a status of “available” is assigned to only one patient at any time period, a unit capacity cannot be exceeded at any time period, a temporary assignment cannot be made after a permanent assignment, bed attributes have to match the clinical attributes of a patient for all time periods, and bed reservations can be changed until the time period where the patient is admitted as an inpatient. Examples of “soft” constraints may include: meet a desired level of unit utilization, meet a desired level of staff-patient ratio, minimize gender mismatch within semi-private rooms, meet a desired user room type requirements with minimum deviations, and minimize the wait time between bed request/transfer and actual placement of the patient.

The bed assignment problem may be formulated as a linear goal programming problem generalized to handle multiple conflicting desired goals. The soft constraints may be modeled as goals and each of these goals is given a target value to be achieved. The objective is to minimize the unwanted deviations from this set of target values. Each of these goals may be weighted according to specified user preferences.

The continuous automated bed management system 1750 may include a bed management module 1752 to provide information about the bed status of different beds and allow a manager to assign unique attributes to the bed. The bed management module 1752 may also allow the manager to request services for the bed such as cleaning, maintenance, transport, etc.

The continuous automated bed management system 1750 may also include a bed request module 1754 to provide information about the patient bed requests, the request status, and allow the bed requestor to assign unique attributes to the requests and/or enter notes pertinent to the request. This module 1754 allows the manager to visualize the clinical and nonclinical attributes of the patient and also allows manual overrides of the assignments made by the algorithm. The bed request module 1754 may also allow for the manual processing of patients for whom assignments were not possible and for reservations and cancellations of beds for patients in the system 1700.

The continuous automated bed management system 1750 may also include a census visualization and reporting module 1756 to display visual information about the location of the patients, the location of beds and which beds the patients are assigned to. The module 1756 may also allow visualizations of which nurse is assigned to patients once the nurse-patient assignment has been realized and provide census information over time. The module 1756 might also display historical information and current information of computed parameters related to the patient flows along with census information, staff to patient ratios, unit utilizations, average patient wait time ratios, average response time for bed cleaning and maintenance, average response time for discharge of the patient and the key patient flow parameters such as arrival rates, discharge rates, length of stay, etc.

The continuous automated bed management system 1750 may also include a system configuration module 1758 to display information about the manager's rank ordering of the preferences for managing different assignment and patient flow goals. The module 1758 allows the manager to set the time interval after which the algorithm executes itself to process bed-patient assignments lets the manager set a time horizon to be considered by the algorithm.

Note that the system 1700 might execute using “snapshot” or substantially real time data. According to some embodiments, the system 1700 runs periodically and can also run when requested by a manager to provide current and summarized information about the bed management process and the patient flow status within the entire system (e.g., such that the system 1700 considers 8 hours as the time horizon and 15 minutes as its time interval).

According to some embodiments, the decision system 1730 uses the results of a predictive simulation model 1740 to facilitate resource assignments (e.g., bed, staff, and/or equipment assignments). For example, a bed may be available now in a patient's “top-tier” unit, but the predictive model 1740 may indicate that that particular unit will be full or blocked by tomorrow morning. In this case, the decision system 1730 might bypass the preferred unit and instead place the patient in a lower tier unit. Similarly, the predictive model 1740 might show that a unit will have alternating periods of availability and blockage over the next 24 hours. In this case, the decision system 1730 might consider availability at a particular time (e.g., 6:00 AM tomorrow), an average availability over a pre-determined period of time, a minimum availability over a pre-determined period of time, etc. In one approach, low availability in a unit may result in the algorithm applying a detrimental weight to all beds in that unit (making it less likely that beds will be selected from that unit). The weighting might be, for example, proportional to the predicted availability. According to some embodiments, the decisioning system 1730 might recommend, for example, that underutilized unit be closed (and patients be consolidated into another unit).

The decision system 1730 and/or predictive simulation model 1740 may, according to some embodiments, “learn” to improve algorithms based on actual results that occur in the hospital. That is, assignment policies, rules, factors, and/or weights may be adjusted to improve patient workflow. For example, if nurses consistently override the system 1700 to avoid placing a particular type of patient in a particular type of bed or unit, the system 1700 may avoid such placements in the future. Note that such a learning process might be manually or automatically implemental and may be perform on an on-going or off-line basis.

Although patient beds have been used herein with respect to some examples, note that other types of medical resources, such as staff and equipment providing medical care to patients, may be similarly managed. For example, the system 1700 may attempt to reach a particular nurse-to-patient ratio (which might vary from unit to unit). According to some embodiments, the predictive model 1740 may be used to facilitate such automated resource management. According to other embodiments, the decision unit 1730 may use historical data to make such adjustments (in addition to or instead of data from the predictive model 1740).

Thus, some embodiments described herein may provide a continuous automated system 1700 for bed-patient and other resources assignments. The system 1700 may consider patient assignments over a time horizon and may run periodically to automatically assign patients to beds with minimal human intervention. The system 1700 may be flexible, adapt to the dynamic nature of the system 1700, be configurable, visually interpretable and allow for management of various patient flow goals. Moreover, the system 1700 may provide nurse-patient assignments subsequent to the completion of bed-patient assignments.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

Applicants have discovered that embodiments described herein may be particularly useful in connection with resource assignments for a healthcare enterprise. Note, however, that other types of assignments may also benefit from the invention.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A method, comprising:
continuously and automatically receiving current resource data indicative of a current state of resources that are used to deliver healthcare to a plurality of patients associated with a healthcare enterprise;
automatically using the current resource data to update a healthcare enterprise simulation model executed by a computer processor;
executing, by the computer processor, the healthcare enterprise simulation model to automatically generate a predicted future state of the resources;
receiving a resource request; and
automatically assigning, by a resource assignment engine, a particular resource to the resource request based at least in part on the predicted future state of the resources.

2. The method of claim 1, further comprising:
outputting a response to the resource request recommending the particular resource that was assigned to the resource request.

3. The method of claim 1, further comprising:
automatically arranging to provide the particular resource that was assigned to the resource request.

4. The method of claim 1, wherein said receiving the current resource data is performed in substantially real time.

5. The method of claim 1, wherein the resources are associated with at least one of: (i) patient beds, (ii) healthcare staff who provide treatment to the plurality of patients associated with the healthcare enterprise, and (iii) medical equipment.

6. The method of claim 1, further comprising:
automatically detecting, by the healthcare enterprise simulation model, a potential patient flow bottleneck and said assigning is based at least in part on said detecting.

7. The method of claim 1, further comprising:
providing scheduled future events to the healthcare enterprise simulation model, wherein the predicted future state of the resources is further based on the scheduled future events.

8. The method of claim 1, wherein the predicted future state of the resources is further based on predicted future events.

9. The method of claim 1, wherein said assigning is based at least in part historical information of the healthcare enterprise.

10. The method of claim 1, further comprising:
prior to said receiving, configuring the resource assignment engine.

11. The method of claim 10, wherein said configuring comprises:
defining a plurality goals; and
for each defined goal, assigning a level of importance to that goal.

12. The method of claim 1, wherein the healthcare enterprise simulation model is based at least in part on patient flow molecules, each molecule being associated with: (i) a prior state, (ii) an enter time, (iii) a past length of service, (iv) a remaining length of service, (v) a current state, (vi) a patient attribute, (vii) a departure time, and (viii) a next state.

13. The method of claim 12, wherein the healthcare enterprise comprises a hospital and at least one of the treatment units are associated with at least one of: (i) an emergency department, (ii) an outpatient unit, (iii) a holding room, (iv) an operating room, (v) a recovery room, (vi) a cardiac treatment unit, (vii) a physical therapy unit, (viii) a laboratory, (ix) an X-ray and MRI unit, and (x) an intensive care unit.

14. The method of claim 1, further comprising:
automatically monitoring assigned resources; and
based on said monitoring, automatically adjusting at least one of the resource assignment engine or the healthcare enterprise simulation model to improve future performance.

15. The method of claim 1, wherein the current resource data comprises real time location system information.

16. A system, comprising:
an input port to receive current resource data indicative of a current state of resources that are used to deliver healthcare to a plurality of patients associated with a healthcare enterprise;
a healthcare enterprise simulation model platform including a computer processor to:
use the received current resource data to execute a healthcare enterprise simulation model and generate a predicted future state of the resources;
a resource assignment engine to:
receive a resource request, and
assign a particular resource to the resource request based at least in part on the predicted future state of the resources.

17. The system of claim 16, wherein the resource assignment engine is further to:
prior to said receiving, being configuring with a defined plurality goals and, for each defined goal, an assigned level of importance to that goal.

18. A non-transitory, computer-readable medium storing instructions that, when executed by a computer processor, cause the computer processor to perform a method, the method comprising:
continuously receiving current hospital bed data indicative of a current state of hospital beds that are used to deliver healthcare to a plurality of patients associated with a healthcare enterprise;
using the current hospital bed data to update a healthcare enterprise simulation model;
executing the healthcare enterprise simulation model to automatically generate a predicted future state of the hospital beds;
receiving a hospital bed request; and
assigning a particular hospital bed to the hospital bed request based at least in part on the predicted future state of the hospital beds.

19. The medium of claim 18, wherein the predicted future state of the hospital beds is further based on: (i) scheduled future events, and (ii) predicted future events.

20. The medium of claim 18, wherein the method further comprises:
prior to said receiving, configuring a resource assignment engine by defining a plurality goals, and, for each defined goal, assigning a level of importance to that goal.
